(19) United States
(12) Patent Application Publication
(10) Pub. No.: US 2006/0197012 A1
(43) Pub. Date: Sep. 7, 2006

(54) Shear and pressure/transverse strain fiber grating sensors

(76) Inventors: Eric Udd, Fairview, OR (US); Sean Geoffrey Calvert, Troutdale, OR (US); Stephen Tod Kreger, Fairview, OR (US)

Correspondence Address: Eric Udd;Blue Road Research, 376 NE 219th Avenue, Gresham, OR, 97030, US

(21) Appl. No.: 11/071,959

(22) Filed: Mar. 4, 2005

(51) Int. Cl. G01J 1/04

(52) U.S. Cl. 250/227.14

(57) ABSTRACT

A fiber grating that is written into birefringent optical fiber may be placed between two loading plates and bonded in place. The principal polarization axes of the fiber grating written into birefringent optical fiber are approximately 45 degrees relative to the plane of the loading plates and utilizing spacers of a thickness approximately equal to the diameter of the fiber grating written onto birefringent fiber between the plates to measure shear. The principal polarization axes of the fiber grating written onto birefringent optical fiber at approximately 90 degrees relative to the loading plates may be used to measure pressure. When the top and bottom loading plates are of unequal size adhesive and strain relief tubes may be used in conjunction with the loading plates to provide strain relief to the shear and pressure sensors.

This application claims the benefit of U.S. Provisional Application No. 60/552844 by Eric Udd, Stephen Kreger, and Sean Calvert entitled, “Shear and Pressure/Transverse Strain Fiber Grating Sensors” which was filed on Mar. 12, 2004. This invention was made with Government support from contracts DAAH01-02-C-R100 and W31P4Q-o4-C-R010 awarded by the US Army Aviation and Missile Command. The government has certain rights to this invention.

### BACKGROUND OF THE INVENTION

This disclosure describes means to measure shear strain and pressure/transverse strain.

This invention relates generally to fiber optic grating systems and more particularly, to the measurement 4 of strain fields using fiber optic grating sensors and their interpretation. Typical fiber optic grating sensor systems are described in detail in U.S. Pat. Nos. 5,380,995, 5,402,231, 5,592,965, 5,841,131 and 6,144,026.

The need for low cost, a high performance fiber optic grating environmental sensor system that is capable of long term environmental monitoring, virtually immune to electromagnetic interference and passive is critical for many applications. This system has the capability of providing accurate measurements of pressure/transverse strain and shear strain at multiple locations along a single fiber line with high accuracy and stability under severe environmental conditions.

In U.S. Pat. Nos. 5,591,965, 5,627,927 the usage of fiber gratings to detect more than one dimension of strain is described. These ideas are extended in U.S. Pat. Nos. 5,828,059, 5,869,835, and 5,841,131 to include fibers with different geometries that can be used to enhance sensitivity or simplify alignment procedures for enhanced sensitivity of multi-parameter fiber sensing. An important application of multi-parameter fiber sensing using fiber grating is to used transverse force applied to a fiber grating to measure pressure and temperature. The relevant US Patents for these types of measurements are U.S. Pat. Nos. 5,828,059, 5,841,313, 6,218,661 and 6,363,180.

All of these patents teaching are background for the present invention which is described more fully in association with the drawings below.

### BRIEF DESCRIPTION OF THE PRESENT INVENTION

In the present invention optimized packages are described for implementing fiber grating based shear and pressure/transverse force transducers. By utilizing quartz designs and minimizing the usage of other materials temperature effects on the pressure and shear measurement can be minimized and the shear and pressure/transverse force transducers arranged so that temperature may also be measured accurately. Strain relief associated with the optical fibers exiting the transducer is provided by extending the lower plate on which the shear and pressure/transverse force transducers are mounted. Rotational alignment of birefringent fiber that may be polarization preserving is provided through the usage of tabs mounted onto the bottom plate. Additional strain relief is provided through the usage of strain relief tubes and soft flexible adhesive materials. Because of prior art the invention improvements related to the pressure/transverse force transducers are limited to packaging improvements that result in better performance and superior environmental ruggedness. The novel fiber grating shear strain sensors utilize many common design elements with the improved pressure/transverse force transducers and is the principal invention associated with this disclosure.

Therefore it is an object of the invention to provide a fiber grating sensor capable of measuring shear.

It is another object of the invention to measure shear and temperature.

Another objective of the invention is to provide an environmentally rugged package suitable for shear force measurements.

Another object of the invention to provide an environmentally rugged package with characteristics similar to that employed for shear force measurements to support pressure/transverse force measurements.

### BRIEF DESCRIPTION OF THE DRAWINGS

FIG. 1 is a diagram illustrating a prior art multi-axis fiber grating strain sensor.

FIG. 2 is a graphical illustration of the spectral reflection of a multi-axis fiber grating strain sensor transversely loaded along one of its principal transverse axes.

FIG. 3 is an end on diagram illustrating a pressure/transverse force transducer formed by orienting a multi-axis fiber grating strain sensor between hard plates with one of its principal axes oriented out of the plane and mounted using adhesives.

FIG. 4 is an end on diagram illustrating a pressure/transverse force transducer using small diameter optical fiber spacers to secure and insure uniform spacing of the ends of the loading plates.

FIG. 5 is an end on diagram illustrating a pressure/transverse force transducer using glass frit as an adhesive to secure the ends of the loading plates.

FIG. 6 shows a shear strain transducer with spacing fibers with the principal transverse axes of the multi-axis fiber grating strain sensor aligned at 45 degrees relative to the plane of the loading plates and adhesive used to bond the assembly.

FIG. 7 shows a shear strain transducer with spacing fibers with the principal transverse axes of the multi-axis fiber grating strain sensor aligned at 45 degrees relative to the plane of the loading plates and glass frit used to laser weld or torch weld the attachment points of the optical fibers to the loading plates.

FIG. 8 is a diagram illustrating the top view of (a) the bottom loading plate and (b) the top loading plate of a package designed to minimize size while providing robust strain relief.

FIG. 9 is a diagram illustrating the placement of the multi-axis fiber grating strain sensor into the transducer package providing strain relief and mounting surfaces for alignment tabs of the transverse stain axes of the multi-axis fiber grating strain sensor.

FIG. 10 is a side and top view of a multi-axis fiber grating sensor placed in a strain relief package to measure pressure/transverse strain.

FIG. 11 is a side and top view of a multi-axis fiber grating sensor placed in a strain relief package to measure pressure/transverse strain with an additional adhesive strain relief area.

FIG. 12 is a side and top view of a multi-axis fiber grating sensor placed in a strain relief package to measure shear strain.

FIG. 13 is a side and top view of a multi-axis fiber grating sensor placed in a strain relief package to measure shear strain with an additional adhesive strain relief area.

### DETAILED DESCRIPTION OF THE SHOWN EMBODIMENTS

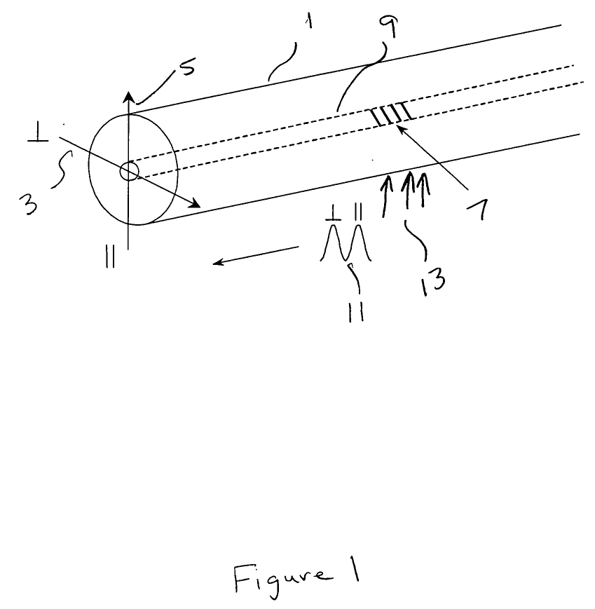

FIG. 1 shows a prior art multi-axis fiber grating strain sensor. It consists of a birefringent optical fiber, which has two orthogonal axes 3 and 5 that have different indices of refraction. A fiber grating 7 is written onto the core 9 of the birefringent optical fiber. This results in two effective fiber gratings, one along each of the axes 3 and 5. When a broadband light source is used to illuminate the fiber grating 7 the reflection spectra 11 has two spectral peaks corresponding to the portions of the fiber grating 7 lying along the axes 3 and 5 respectively. When transverse force 13 is applied to the birefringent optical fiber 1 in the region of the fiber grating 7 along one of the polarization axes 3 or 5 the two spectral peaks 11 will move apart or together depending on the axis being loaded and whether the transverse force is compression or tension.

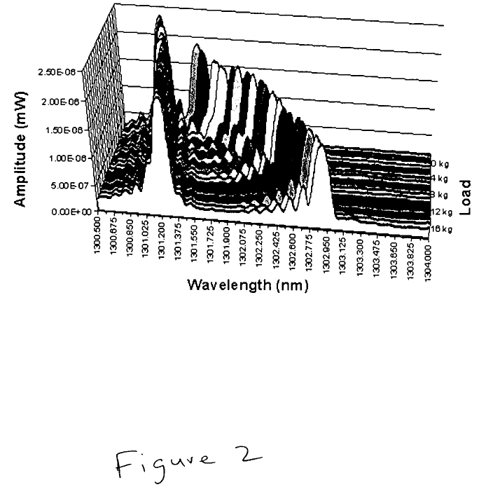

FIG. 2 is a graphical representation of experimental data of a multi-axis fiber grating strain sensor similar to that shown in FIG. 1 being loaded in compression along the axis that has a higher index of refraction than the orthogonal axis. The increased compression causes the index of refraction of the fiber to go up along this axis and the spectral peak corresponding to this axis moves toward longer wavelengths as the effective spacing of the fiber grating increases. The effect along the orthogonal axis is much smaller with the net result being the two spectral peaks moving apart with increased load.

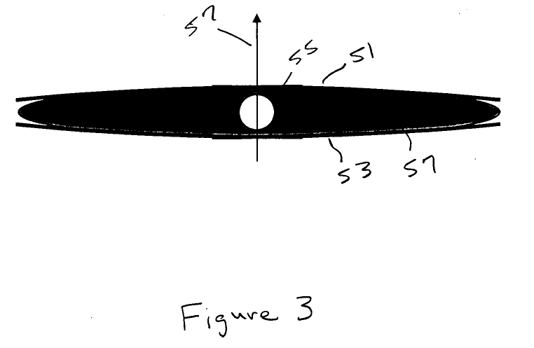

By utilizing multi-axis fiber grating sensor appropriately oriented in loading fixtures shear and pressure/transverse force sensor may be realized. FIG. 3 shows a configuration that is suitable for a pressure/transverse force sensor. Two flat load plates 51 and 53 are arranged on either side of a multi-axis fiber grating sensor 55 with one of its principal axes aligned so that it is orthogonal to the plane of the load plates 51 and 53. Adhesive material is positioned between the load plates 51 and 53 around the multi-axis fiber grating strain sensor 55. The ends of the load plates 51 and 53 are clamped while the adhesive 57 cures so that there is a net compression along the principle axis 57 of the multi-axis fiber grating strain sensor 55. Alternatively an adhesive that shrinks during cure or with a cure temperature higher than the operational temperature and a high thermal expansion coefficient may provide sufficient compression of the load plates 51 and 53 without clamping. In general if the compression induced by bending the load plates 51 and 53 is great enough than it is not necessary to use birefringent optical fiber as the load plates 51 and 53 will induce spectral splitting by the transverse loading force in the fiber 55. As a practical matter clear separation between the two spectral peaks from the multi-axis fiber grating stain sensor 55 simplifies signal processing and birefringent fiber such as polarization preserving optical fiber may be desirable to support the fiber grating strain sensor 55.

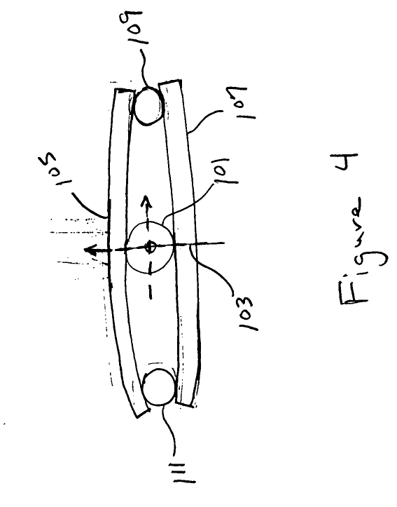

FIG. 4 shows an embodiment of a pressure/transverse force transducer. An optical fiber 101 that may be birefringent is mounted with one of its principal transverse axes 103 orthogonal to the plane of top 105 and bottom 107 transducer plates. The plates 105 and 107 that may be quartz, fused silica, glass or ceramic with a thermal expansion coefficient close to that of the optical fiber in order to minimize temperature effects are attached to fiber spacers 109 and 111 that have diameters that are slightly less than that of the optical fiber 101 so that a net transverse load is established on the optical fiber grating sensor 101. The attachment of the optical spacer fibers 109 and 111 to the plates 105 and 107 can be accomplished using laser welding or glass frit techniques that may include usage of a torch or plasma discharge.

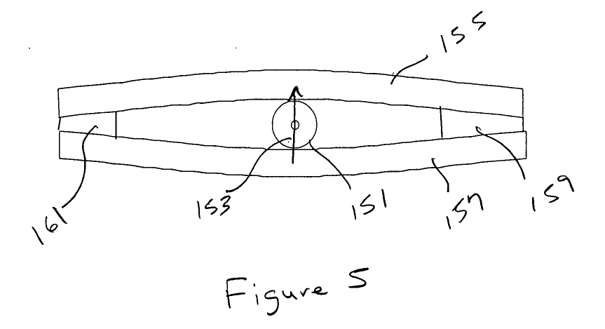

FIG. 5 shows an embodiment of a pressure or transverse force transducer which has many features in common with that shown in FIG. 4. In the case of FIG. 5 an optical fiber grating sensor 151 that may be written into birefringent optical fiber is aligned with one of its principal polarization axes 153 orthogonal to the loading plates 155 and 157. The loading plates 155 and 157 are preloaded onto the optical fiber grating sensor 151 and attached at their ends by bonds 159 and 161 that may be formed by using glass frit. If the bonds 159 and 161 are formed by glass frit and the loading plates 155 and 157 are made of quartz the thermal expansion coefficient of the optical fiber grating sensor 151 is closely matched and it is possible to separate out pressure/transverse force and temperature by monitoring the two spectral peaks associated with the optical fiber grating sensor 151 which it is under load due to pressure or transverse force.

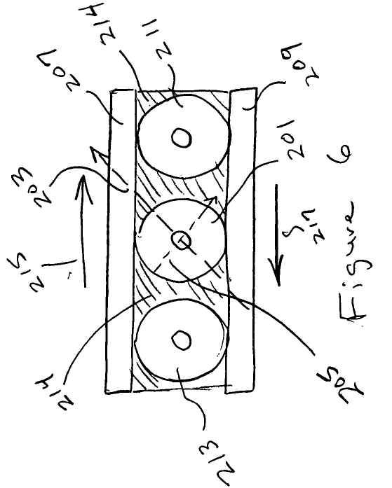

FIG. 6 is a diagram of a shear sensor based on utilization of a multi-axis fiber grating strain sensor 201 whose principal transverse axes 203 and 205 are aligned at 45 degrees relative to the loading plates 207 and 209. The plates 207 and 209 are spaced by the optical fibers 211 and 213 which have diameters that are approximately equal to that of the multi-axis fiber grating strain sensor 201 that is placed between them. Adhesive bonding material 214 is used to bond the optical fibers 201, 211 and 213 to the loading plates 207 and 209. When shear forces 215 and 217 are applied to the loading plates 207 and 209 the multi-axis fiber grating sensor experiences transverse strain induced by the shear strain forces 215 and 217 along the principal polarization axes 203 and 205. This results in a change in wavelength separation between the spectral reflection peaks associated with the multi-axis fiber grating strain sensor 201 that can in turn be used to measure shear strain.

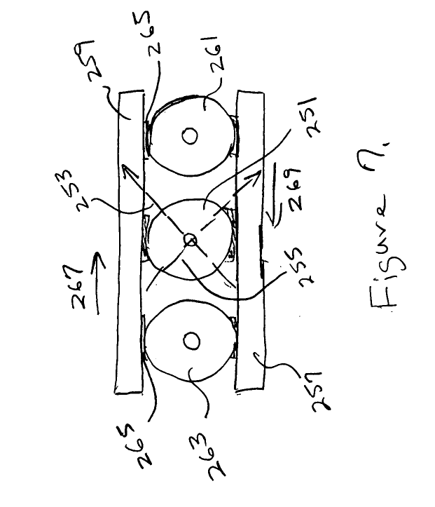

FIG. 7 is a diagram of a shear strain sensor with many features in common with the shear strain sensor described in association with FIG. 6. A multi-axis fiber grating strain sensor 251 is aligned with its principal polarization axes 253 and 255 at 45 degrees relative to the plane of the loading plates 257 and 259. Spacing optical fibers 261 and 263 that have diameters approximately equal to that of the multi-axis fiber grating strain sensor 251 are used to keep the separation between the loading plates 257 and 259 approximately equal over their surface area. The optical fibers 251, 261 and 263 are bonded to the loading plates 257 and 259 with a bond 265 that may be formed using glass frit or laser welding techniques. When shear forces 267 and 269 are applied to the loading plates 257 and 259 a transverse force is applied along the principal polarization axes 253 and 255 of the multi-axis fiber grating strain sensor 251. This results in a change in the wavelength separation between spectral peaks associated with the multi-axis fiber grating strain sensor 251 that can in turn be used to measure shear strain.

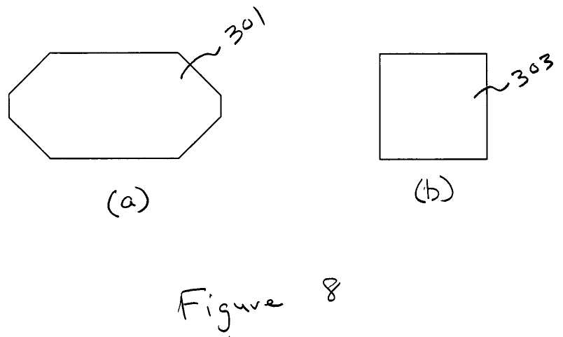

FIG. 8 is a diagram illustrating a top view of load plates that may be associated with a shear strain sensor to improve environmental performance while minimizing overall size. FIG. 8a shows a top view of the bottom loading plate 301 that may be associated with an improved package for a pressure/transverse strain or shear strain sensor. FIG. 8b shows a similar view associated with the top plate 303. The top plate 303 is smaller so that strain relief provisions may be made in association with the bottom plate 301.

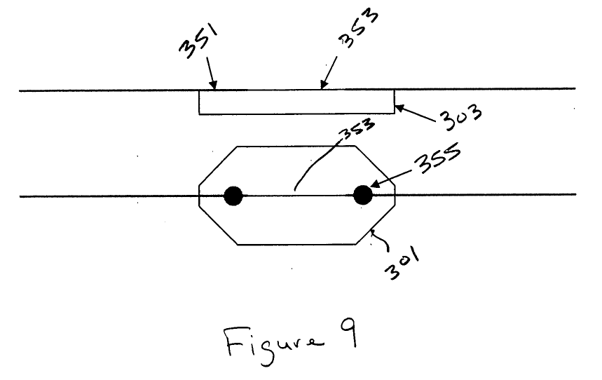

FIG. 9 shows a side view of the top loading plate 303. An optical fiber lead 351 is associated with a multi-axis fiber grating strain sensor 353 that may be positioned near the center of the top plate 303. The bottom plate 301 is again shown with a top view. In this case the position of the multi-axis fiber grating strain sensor 353 is shown relative to the bottom plate 301 as well as an alignment tab 355 that may be a polyimide flat attached to the optical fiber associated with the multi-axis fiber grating strain sensor 353.

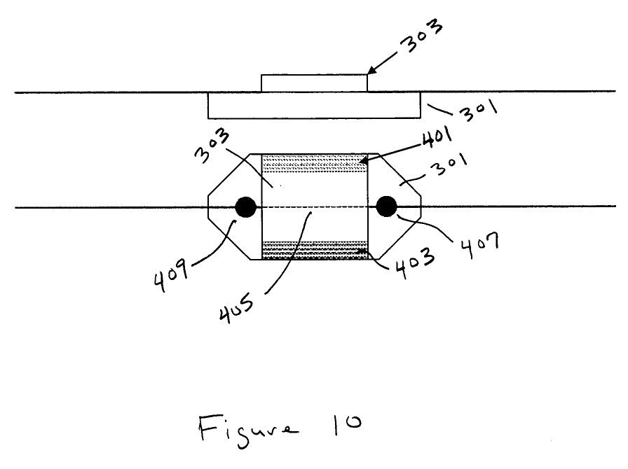

FIG. 10 is a side and top view of the top loading plate 303 and the bottom loading plate 301 aligned to support a pressure/transverse force sensor. The top plate 303 is attached to the bottom plate 301 with bonds 401 and 403 that may be formed using glass frit. The multi-axis fiber grating strain sensor 405 is preloaded along an axis orthogonal to the plane of the loading plates 301 and 303. The alignment tabs 407 and 409 are positioned on the optical fiber leads associated with the multi-axis fiber grating strain sensor 405 to insure the polarization axes are aligned properly during assembly. The tabs 407 and 409 may be attached to the bottom loading plate 301 or removed prior to final assembly depending on manufacturing requirements.

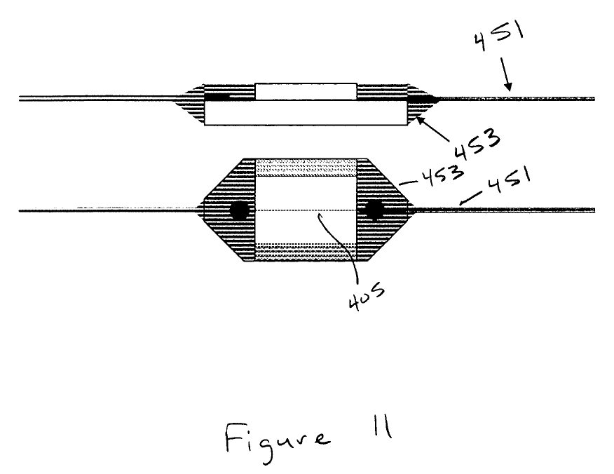

FIG. 11 shows that protective tubing 451 may be placed over the optical fiber leads associated with the multi-axis fiber grating strain sensor 405 and the tubes attached to the top and bottom load plates 301 and 303 through the usage of an adhesive 453.

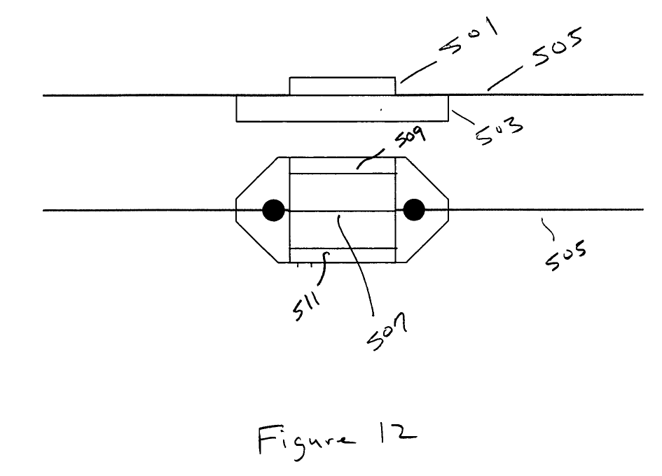

FIG. 12 illustrates a configuration suitable for a rugged environmental package for a shear strain sensor. A top loading plate 501 is positioned over a bottom loading plate 503 with an optical fiber 505 containing a multi-axis fiber grating strain sensor 507 that is aligned with its principal polarization axes at 45 degrees relative to the plane of the loading plates 501 and 503. Spacing between the top and bottom loading plates is controlled by the spacing optical fibers 509 and 511 which have diameters that are substantially the same as the multi-axis fiber grating strain sensor 505. The top and bottom loading plates 501 and 503 would be attached to the multi-axis fiber grating strain sensor 505 and the spacing optical fibers 509 and 511 using adhesives as in FIG. 6 or glass frit techniques as in FIG. 7.

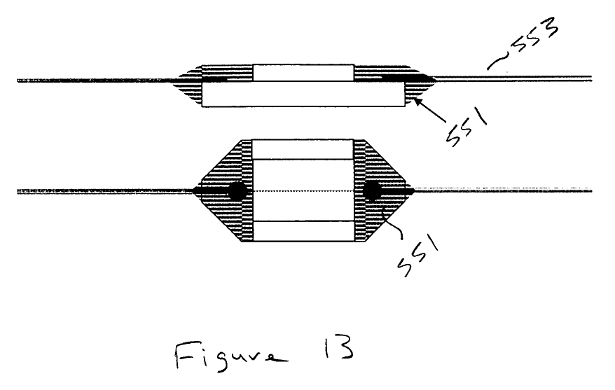

FIG. 13 is a diagram illustrating means to provide strain relief for the shear strain configuration of FIG. 12. Adhesive 551 may be applied to a strain relief tube 553 placed over the lead for the multi-axis fiber grating strain sensor 505.

Thus there has been shown and described novel shear strain and pressure/transverse strain sensors based on fiber gratings which fulfill all the objectives and advantages sought therefore. Many changes, modifications, variations and applications of the subject invention will become apparent to those skilled in the art after consideration of the specification and accompanying drawings. All such changes, modifications, alterations and other uses and applications which do not depart from the spirit and scope of the invention are deemed to be covered by the invention which is limited only by the claims that follow:

What is claimed is:

1. A fiber optic grating shear sensor including:
a fiber grating written onto birefringent optical fiber;
a first loading plate located on top of said fiber grating written onto birefringent optical fiber;
a second loading plate located below said fiber grating written onto birefringent optical fiber;
a first spacer located to the right of said fiber grating written onto birefringent fiber,
a second spacer located to the left of said fiber grating written onto birefringent fiber;
major polarization axes of said fiber grating written onto birefringent fiber being oriented at an angle relative that is approximately 45 degrees relative to the plane of said first and second loading plates;
a bond between said fiber grating written onto birefringent optical fiber and said first and second loading plates;
a bond between said first and second spacing optical fibers and said first and second loading plates;
whereby shear strain may be determined.

2. A fiber optic grating shear sensor as defined in claim 1 wherein said first and second loading plates are quartz.

3. A fiber optic grating shear sensor as defined in claim 1 wherein said bond is an adhesive.

4. A fiber optic grating shear sensor as defined in claim 1 wherein said bond is a weld.

5. A fiber grating shear sensor as defined in claim 1 wherein said bond is a solder.

6. A fiber optic grating shear sensor as defined in claim 1 wherein said first and second spacers are optical fibers.

7. A fiber optic grating shear sensor as defined in claim 1 wherein said first loading plate of a different size than said second loading plate.

8. A fiber optic grating shear sensor as defined in claim 6 wherein optical fiber leads for said fiber grating written into birefringent fiber are encapsulated in an adhesive and mounted to the surfaces of said first and second loading plates.

9. A fiber optic grating shear sensor as defined in claim 7 wherein said optical fiber leads are placed in strain relief tubes.

10. A fiber grating pressure sensor including:
a fiber grating written onto birefringent optical fiber;
a first loading plate located on top of said fiber grating written onto birefringent optical fiber;
a second loading plate located below said fiber grating written onto birefringent optical fiber;
major polarization axes of said fiber grating written onto birefringent fiber being oriented at an angle relative that is approximately 90 degrees relative to the plane of said first and second loading plates;
a bond at the edges between said first and second loading plates;
said first loading plate being different in size from said second loading plate;
whereby pressure may be determined.

11. A fiber grating pressure sensor as defined in claim 9 wherein said bond is formed by glass frit

12. A fiber grating pressure sensor as defined in claim 9 wherein said bond includes spacer fibers.

13. A fiber grating pressure sensor as defined in claim 9 wherein said first and second loading plates are quartz.

14. A fiber grating pressure sensor as defined in claim 9 wherein optical fiber leads for said fiber grating written into birefringent fiber are encapsulated in an adhesive and mounted to the surfaces of said first and second loading plates.

15. A fiber grating pressure sensor as defined in claim 13 wherein said optical fiber leads are placed in strain relief tubes.

16. A fiber optic grating shear sensor including:
a fiber grating written onto birefringent optical fiber;
a first loading means located on top of said fiber grating written onto birefringent optical fiber;
a second loading means located below said fiber grating written onto birefringent optical fiber;
a first spacing means located to the right of said fiber grating written onto birefringent fiber,
a second spacing means located to the left of said fiber grating written onto birefringent fiber;
major polarization axes of said fiber grating written onto birefringent fiber being oriented at an angle relative that is approximately 45 degrees relative to the plane of said first and second loading means;
a bonding means between said fiber grating written onto birefringent optical fiber and said first and second loading means;
a bonding means between said first and second spacing means and said first and second loading means;
whereby shear strain may be determined.

17. A fiber optic grating shear sensor as defined in claim 15 wherein said first and second loading means are first and second quartz plates.

18. A fiber optic grating shear sensor as defined in claim 15 wherein said first and second spacing means are optical fibers.

19. A fiber optic grating shear sensor as defined in claim 16 wherein said first and second quartz plates are of unequal size.

20. A fiber optic grating shear sensor as defined in claim 15 wherein optical leads for said fiber grating written onto birefringent fiber are adhesively bonded to said loading means.

21. A fiber optic grating shear sensor as defined in claim 18 wherein said optical leads are in a strain relief tube.
